(19) United States
(12) Patent Application Publication
(10) Pub. No.: US 2025/0193303 A1
(43) Pub. Date: Jun. 12, 2025

(54) LAMINATED MAGNETIC PHONE HOLDER

(71) Applicant: Case-Mate, Inc., Atlanta, GA (US)

(72) Inventors: Jonathan Asher RUBY, Sandy Springs, GA (US); Saumil Chetan MODY, Atlanta, GA (US)

(21) Appl. No.: 19/059,777

(22) Filed: Feb. 21, 2025

Related U.S. Application Data
(63) Continuation-in-part of application No. 18/522,972, filed on Nov. 29, 2023.
(60) Provisional application No. 63/556,653, filed on Feb. 22, 2024.

(51) Int. Cl. H04M 1/04; F16M 11/12; H04B 1/3827

(52) U.S. Cl. CPC H04M 1/04; F16M 11/125; H04B 1/385; H04B 2001/3861

(57) ABSTRACT

A holder and support apparatus for a mobile electronic device, the holder and support apparatus including an attachment base portion for attachment to the mobile electronic device and a support portion pivotally coupled to the attachment base portion. A laminated covering is applied over at least a portion of the attachment base portion.

### CROSS-REFERENCE TO RELATED APPLICATIONS

This application claims priority to U.S. Patent Application Ser. No. 63/556,653 filed Feb. 22, 2024; this application is a continuation-in-part of U.S. patent application Ser. No. 18/522,972, filed Nov. 29, 2023, both of which are hereby incorporated herein by reference.

### TECHNICAL FIELD

The present invention relates generally to the field of accessories for mobile electronic devices, and more particularly to a magnetic holder and stand device for attachment to a mobile phone or other portable electronic device to allow a user to hold the device more easily and to position the device in various configurations and orientations.

### BACKGROUND

Mobile phones and other portable electronic devices can be difficult to hold and operate for some users and in some applications, for example with larger devices and/or in single-handed modes of use. Damage caused by dropping a mobile electronic device can be very expensive. Users may also wish to support their mobile electronic devices in one or more hands-free standing positions or orientations, for example when viewing media on the device. Previously known magnetic phone holders typically have exposed rigid frames, which may be undesirable for appearance, feel and functionality to a user.

Accordingly, it has been found that needs exist for improved accessories for mobile phones and other portable electronic devices to assist a user in securely holding the device and/or for supporting the device. It is to the provision of improved accessories for mobile phones and other portable electronic devices meeting these and other needs that the present invention is primarily directed.

### SUMMARY

In example embodiments, the present invention provides a holder and stand accessory apparatus for a mobile phone or other mobile electronic device. The holder and stand accessory can be magnetically attached to a phone or other mobile device, to a protective or decorative case containing the mobile device, or to other magnetically or adhesively attached components engaged with the device.

The holder and stand device preferably includes a magnetic attachment portion comprising one or more permanent magnets providing strong and secure magnetic engagement with the phone or other electronic device, and includes a ring-shaped element hingedly or pivotally attached to the magnetic attachment portion allowing a user to securely hold the device by positioning a finger through the ring-shaped element, and/or to stand the device in one or more hands-free positions or orientations on a support surface.

A laminated cover material may be provided over and around all or a portion of the magnetic attachment portion, with an opening in the laminate covering through which a connecting member extends to securely couple the hinged ring with the magnetic attachment portion. In example embodiments of the present invention, the rigid frame of the holder and stand device is encased in a laminate covering construction and the application of such cover materials allows for unique and improved aesthetic appearances, feel and functionality, not provided by previously known devices.

In one aspect, the present invention relates to a holder and support apparatus for a mobile electronic device. The holder and support apparatus preferably includes an attachment base portion for attachment to the mobile electronic device, having a frame and a laminated covering material applied over at least a portion of the frame. The holder and support apparatus preferably also includes a support portion pivotally coupled to the attachment base portion.

In another aspect, the laminated covering over the frame of the attachment base portion includes an opening through which a coupling portion extends between the frame of the attachment base portion and the support portion.

In still another aspect, the present invention relates to a method of manufacture of a holder and support apparatus for a mobile electronic device, the method comprising providing an attachment base portion, and applying a laminated covering over at least a portion of the attachment base portion.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIGS. 1A and 1B show a laminated magnetic phone holder according to an example embodiment of the invention, with the ring-shaped holder or support element in retracted and extended configurations, respectively.

FIG. 2 shows a perspective view in a partial cross-section with details of the laminate cover construction according to an example embodiment of the invention.

FIG. 3 shows the laminated magnetic phone holder with its ring-shaped holder or support element in a rear view position.

FIGS. 4A and 4B show additional cross-sectional views of the magnetic phone holder and further detail of the opening in the laminate cover construction through which the ring holder engages the base via a hinged connection, according to an example embodiment of the invention.

FIGS. 5A and 5B show additional cross-sectional views of the magnetic phone holder and its laminate cover construction according to example embodiments of the invention.

FIGS. 6A, 6B and 6C show additional details of the opening in the laminate cover and the hinged connection between the ring holder and the base, according to an example embodiment of the invention.

FIGS. 7A-7B show the laminated magnetic phone holder used as a support stand to hold a mobile phone in various positions.

FIGS. 8A and 8B show the laminated magnetic phone holder with its ring holder portion extended to receive a user's finger to hold a mobile phone (FIG. 8A) and retracted in a non-use position (FIG. 8B).

FIG. 9 shows a laminated magnetic phone holder having a first hinged connection location and pivotal support configuration according to an example embodiment of the invention.

FIG. 10 shows a laminated magnetic phone holder having a second hinged connection location and pivotal support configuration according to another example embodiment of the invention.

FIG. 11 shows a laminated magnetic phone holder having a third hinged connection location and pivotal support configuration according to another example embodiment of the invention.

FIG. 12 shows a laminated magnetic phone holder having a fourth hinged connection location and pivotal support configuration according to another example embodiment of the invention.

FIG. 13 shows an assembly view of a laminated magnetic phone holder according to another example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

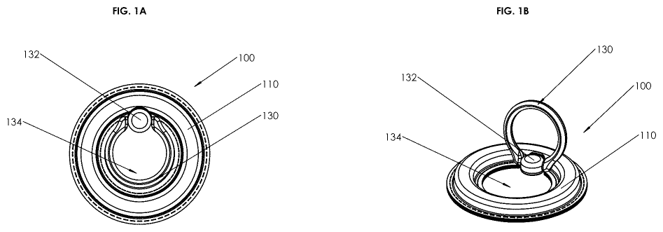

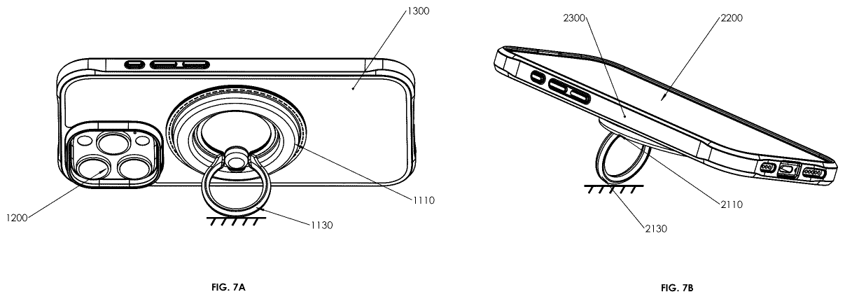

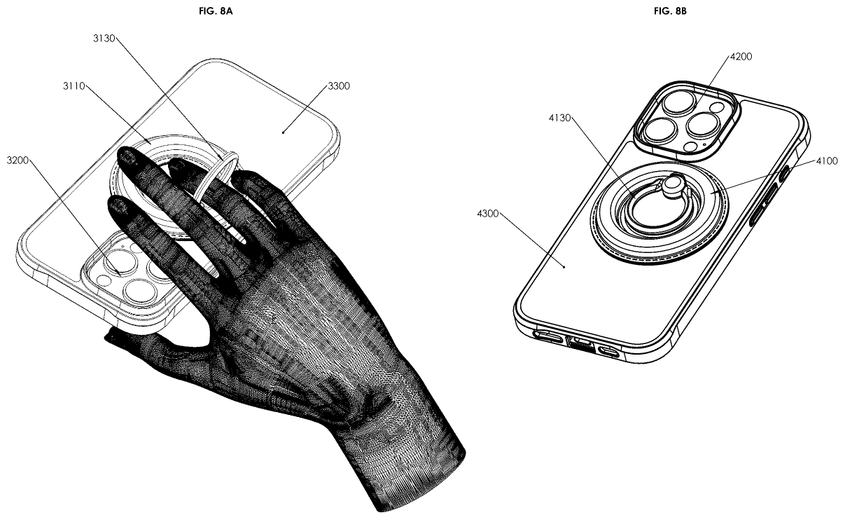

With reference now to the drawing figures, wherein like reference numbers represent corresponding parts throughout the several views, FIG. 1-8 show example embodiments of a laminated magnetic holder apparatus 100 for a mobile phone or other electronic device. The laminated magnetic holder 100 generally comprises a magnetic attachment base 110 for securing the apparatus 100 to the mobile phone or other electronic device (or to a case or other component(s) attached to the mobile phone or other electronic device), and a ring holder or support element 130 hingedly or pivotally coupled to the magnetic attachment base 110 to allow a user to hold the device by positioning a finger through the ring holder 130 in one or more hand-held configurations as best shown in FIG. 8A, and/or to support the device on a support surface in one or more hands-free stand support configurations as best shown in FIGS. 7A-7B. The magnetic attraction and releasable coupling between the laminated magnetic holder 100 and the device is strong enough that the laminated magnetic holder 100 remains attached when supporting the weight of the device and/or case and in normal use of the device, yet weak enough that a user may separate the laminated magnetic holder 100 from the device and/or case through the application of moderate manual force.

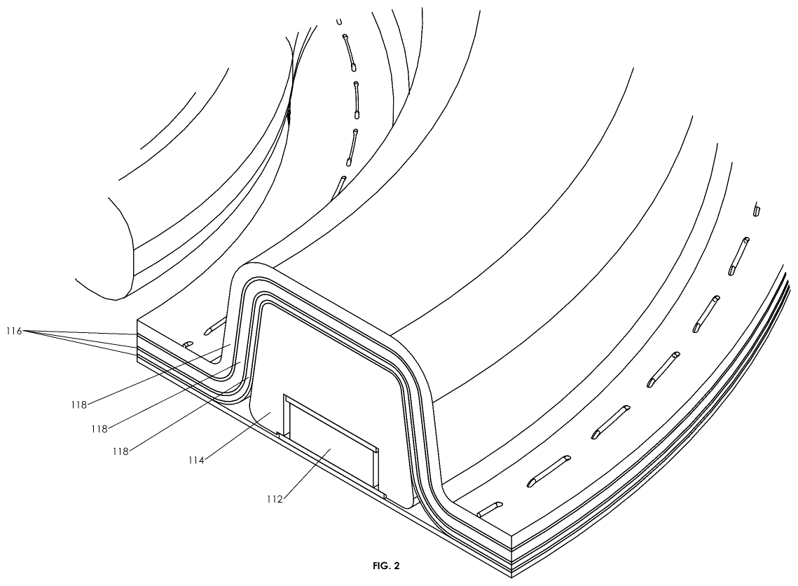

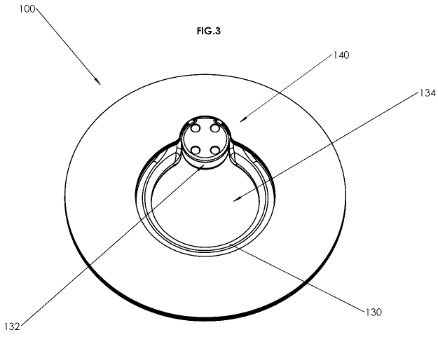

With particular reference to FIGS. 2 and 4A-4B, the magnetic attachment base 110 comprises at least one permanent magnet or magnetic element 112 configured for magnetic attraction and attachment to one or more magnetic components within the phone or other mobile electronic device and/or to a case for the mobile device, such as for example the Apple MagSafe™ magnetic attachment system. The magnetic attraction between the magnetic attachment base 110 and the mobile device allows the holder apparatus 100 to be securely but removably affixed, and therefore removably attached, to the surface of the mobile device or a case or other components attached to the mobile device. In some embodiments, a case attached directly to the mobile device additionally or alternatively comprises one or more magnetic components that magnetically engage the holder apparatus 100 such that the holder apparatus 100 becomes removably attached to the case. In example embodiments, the at least one magnet or magnetic element 112 of the attachment base portion 110 comprises a full or partial circular ring-shaped magnetic array of magnetic element(s) 112 extending substantially continuously 360° around the generally annular body of the attachment base portion 110. In alternate embodiments, the holder apparatus 100 may be attached to a mobile device or case for a mobile device by other or additional attachment means such as hook-and-loop fasteners, releasable adhesive, detachable clips or other couplings, inter-engaging friction-fit elements, threaded or snap couplings, and/or other magnetic arrangements, or the like.

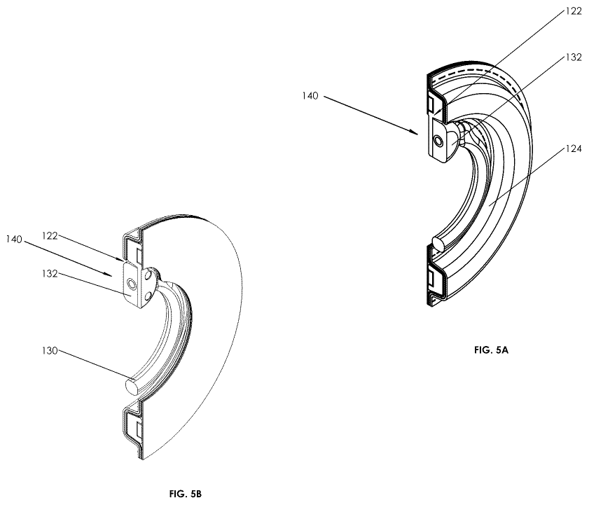

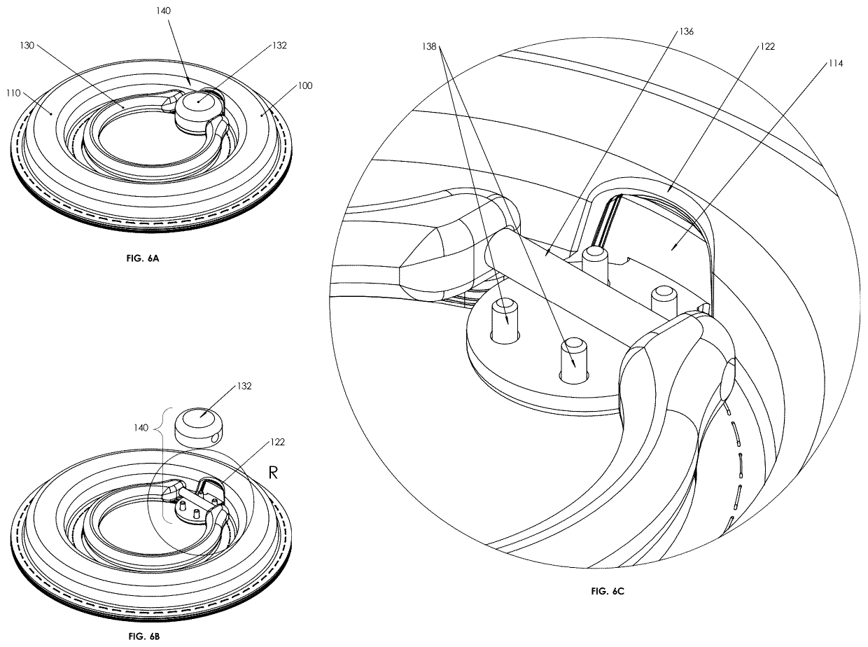

The ring holder or support portion 130 is hingedly or pivotally coupled to the magnetic attachment base 110 by a hinge or pivotal coupling 140, shown in greater detail in FIGS. 6A-6C. One or more fasteners 138, such as for example screws, studs, mounting pins, rivets or other attachment means, may be provided to connect the hinge knuckle coupling 132 to the rigid frame 114 with the magnetic attachment base 110. An interference fit fastening may be provided to connect the hinged pin coupling 136 to the ring holder 130. Hinge knuckle coupling 132 interfaces coaxially with hinged pin coupling 136 to form the hinged or pivotal coupling 140. The ring holder or support portion 130 preferably comprises a generally annular body having an internal opening 134 with a minimum crosswise dimension of at least about 20 mm to allow insertion of a user's finger therethough. In example embodiments, the hinge or pivotal coupling 140 between the ring holder or support portion 130 and the magnetic attachment base 110 provides a range of pivotal motion of the ring holder 130 relative to the attachment base portion 110 spanning an angle of between about 0° (closed) to at least about 90° (open or extended), for example to about 130° or about 140°. Optionally, frictional engagement or indexed positioning in the hinged or pivotal coupling 140 allows the ring holder or support portion 130 to hold and maintain position at any given angle and/or one or more selected angles relative to the attachment base 110.

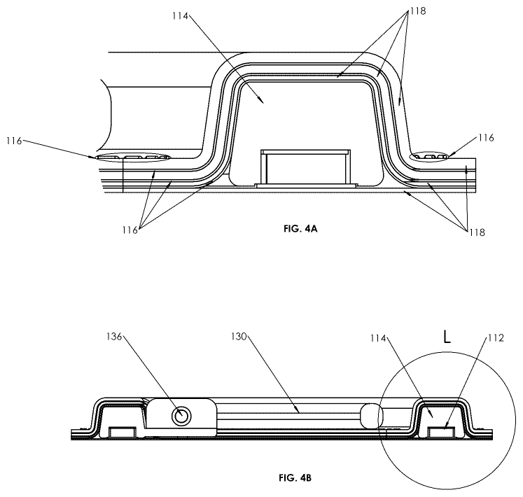

With particular reference to FIGS. 2 and 4A-4B, a covering 118 of flexible formable sheet material or soft goods material is applied over the magnetic attachment base portion 110. The covering 118 may be one or multiple layers laminated and/or bonded over the rigid frame 114 of the magnetic attachment base portion 110, for example by hot melt glue or other adhesive, ultrasonic welding, thermal welding, chemical bonding, stitching or other bonding elements or means. In example embodiments, the covering 118 may comprise laminated layers of polyurethane (PU) synthetic leather, natural animal leather, woven fabric, polycarbonate (PC) film, and/or other/additional liner layer(s) and/or covering material(s) and/or any combinations thereof. The covering material may be provided with an external surface coloring and/or texture for improved aesthetics, and/or improved functionality, such as for durability, non-slip gripping, cushioning, user comfort, retention of marking and/or embossing for labeling or branding, preventing scratching or marring of the device to which it is attached, etc. As shown in FIGS. 5A-5B and 6A-6C, an opening 122 is formed in the laminate covering 118, through which the rigid frame 114 and hinge or pivotal coupling 140 extends to pivotally connect the ring holder 130 to the magnetic attachment base 110. In example forms, the opening 122 is formed in the laminate covering 118 along a generally upright segment of the inner annular surface 124 of the magnetic attachment base 110, and comprises a generally curved or arcuate cutout section profile and an opening size and shape configured to allow sufficient clearance for the hinge or pivotal coupling 140 to provide the desired range of pivotal motion between the ring holder 130 and the attachment base 110.

In some embodiments, the laminated magnetic holder apparatus 1100 may also be used to support the device 1200 and/or the case 1300 on a support surface in one or more hands-free stand support configurations. In the example embodiment shown in FIG. 7A, the attachment base 1110 of the holder apparatus is magnetically attached to the device 1200 and/or the case 1300, and the support element 1130 is positioned translationally relative to the device 1200 and/or the case 1300 such that it is non-concentric with the attachment base 1110. The mobile device 1200 and case 1300 are placed on their edge on the surface such that the support element 1130 contacts the surface so as to provide added stability. In another example embodiment shown in FIG. 7B, the attachment base 2110 of the holder apparatus is magnetically attached to the device 2200 and/or the case 2300, and the support element 2130 is positioned rotationally relative to the device 2200 and/or the case 2300 such that it is non-concentric with the attachment base 2110. The mobile device 2200 and case 2300 are placed on their edge on a surface such that the support element 2130 contacts the surface so as to provide added stability. In some example embodiments, the holder and stand device may be selectively configured by a user to support a mobile phone or other portable electronic device in a vertical or portrait orientation, a horizontal or landscape orientation, and/or other positions or orientations.

With particular reference to FIG. 8A, when the laminated magnetic holder apparatus is magnetically attached to device 3200 and/or the case 3300, the holder portion 3130 may be positioned to be non-concentric with and extending outwardly from the attachment base 3110 to allow a user to hold the device 3200 and/or the case 3300 by positioning an adult user's finger through the ring holder 3130 in one or more hand-held configurations. In another example embodiment, as shown in FIG. 8B, the laminated magnetic holder apparatus 4100 is configured to be removably and magnetically attached to a case 4300 surrounding a mobile device 4200 in the form of a cellphone, and/or directly to the device.

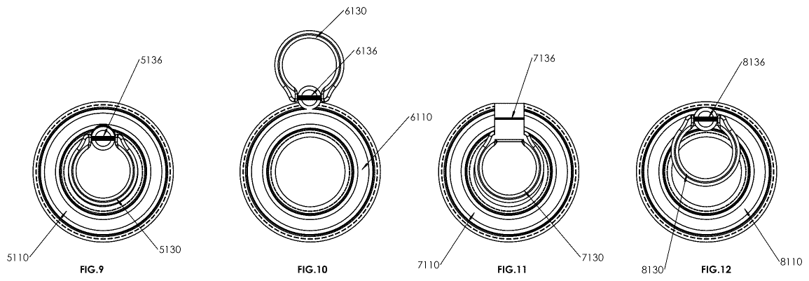

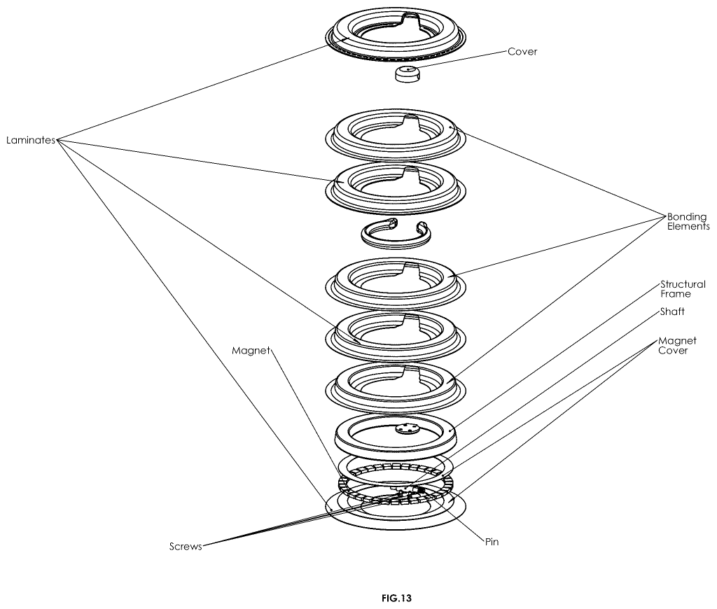

The invention includes various embodiments providing a range of different hinged pin coupling 136 locations and pivotal support configurations, as shown by way of examples in FIGS. 9, 10, 11 and 12. For example, the embodiment of FIG. 9 includes a hinged pin coupling 5136 between the magnetic attachment base 5110 and the ring holder or support element 5130 located at or around the inside diameter of the attachment base 5110. The embodiment of FIG. 10 includes a hinged pin coupling 6136 between the magnetic attachment base 6110 and the ring holder or support element 6130 located at or around the outside diameter of the attachment base 6110. The embodiment of FIG. 11 includes a hinged pin coupling 7136 between the magnetic attachment base 7110 and the ring holder or support element 7130 located in-line with a medial portion of the magnetic attachment base 7110 ring, which may in example embodiments allow for a 180° range of pivotal movement of the ring holder 7130. The embodiment of FIG. 12 includes a hinged pin coupling 8136 between the magnetic attachment base 8110 and the ring holder or support element 8130 located on top of the magnetic attachment base 8110 ring, which also may in example embodiments allow for a 180° range of pivotal movement of the ring holder 8130. In alternate embodiments, a greater or lesser range of pivotal movement and/or indexed positions may be provided by the hinged pin coupling 136, for example ranging between about 45°, 90°, 135°, 225°, and/or through other ranges of motion. The invention further includes embodiments having the hinged pin coupling 136 between the magnetic attachment base 110 and the ring holder or support element 130 located at any position between the above example locations. The different locations and pivotal motion ranges may provide for various support configurations of the electronic device on a support surface, such as portrait or landscape orientations or obliquely tilted orientations, as well as different support angles relative to the support surface, for example between 0° to 90°.

FIGS. 1A-1B, 2 and 13 show an assembly or exploded view of a laminated magnetic phone holder apparatus 100 according to an example embodiment of the invention. In example forms, the phone holder apparatus 100 includes a magnetic attachment base 110, a structural frame 114, a hinged ring holder or support element 130, and a covering material 118, with one or more laminate layers and/or bonding elements 116 joining the components into a unitary assembly.

In use, the laminated magnetic holder apparatus 100 may be removably mounted to a mobile phone or other electronic device by magnetic coupling of the one or more magnet(s) or magnetic elements 112 of the magnetic attachment base portion 110 to cooperatively configured magnetic element(s) of the electronic device or a case or other components attached to the electronic device. The user may selectively position the holder apparatus 100 on the mobile phone or device rotationally and/or translationally, depending on the intended use. The hingedly connected ring holder or support portion 130 may be pivotally extended and retracted to a desired angular position relative to the base portion 110 to allow a user's finger to be inserted therein for hand-held use as a device holder, or to a desired support angle for hands-free use as a support stand. When not in use, the ring holder or support portion 130 may be retracted to a concentric position within the inner annular opening or recess 134 of the attachment base portion 110. If desired, the apparatus 100 may be removed from the phone or other electronic device by detachment of the magnetic attachment base 110 from the device.

While the invention has been described with reference to example embodiments, it will be understood by those skilled in the art that a variety of modifications, additions and deletions are within the scope of the invention, as defined by the following claims.

What is claimed is:

1. A holder and support apparatus for a mobile electronic device, the holder and support apparatus comprising:
an attachment base portion for attachment to the mobile electronic device, comprising a frame and a covering material applied over at least a portion of the frame; and
a support portion pivotally coupled to the attachment base portion.

2. The holder and support apparatus of claim 1, wherein the frame of the attachment base portion comprises at least one magnetic element for engagement with a cooperative magnetic feature of the mobile electronic device.

3. The holder and support apparatus of claim 1, wherein the support portion comprises a ring-shaped element configured to allow a finger of a user to be inserted into an inner opening of the ring-shaped element.

4. The holder and support apparatus of claim 1, wherein a coupling portion extends between the frame of the attachment base portion and the support portion.

5. The holder and support apparatus of claim 4, wherein the pivotal coupling between the support portion and the attachment base portion is located at a position selected from at or around the inside diameter of the attachment base portion, at or around the outside diameter of the attachment base portion, in-line with a medial portion of the attachment base portion, on top of the attachment base portion, and/or at any position between said locations.

6. The holder and support apparatus of claim 4, wherein the pivotal coupling provides a range of pivotal motion enabling various support configurations of the mobile electronic device on a support surface, including a portrait orientation, a landscape orientation, and/or an obliquely tilted orientation.

7. The holder and support apparatus of claim 4, wherein the pivotal coupling provides a range of pivotal motion enabling different support angles of the mobile electronic device relative to a support surface between 0° to 90°.

8. The holder and support apparatus of claim 1, wherein the covering material comprises a material selected from synthetic leather, natural leather, woven fabric, polycarbonate film, or a combination thereof.

9. The holder and support apparatus of claim 8, wherein the covering material is laminated to the frame.

10. A holder and support apparatus for a mobile electronic device, the holder and support apparatus comprising:
an attachment base portion for attachment to the mobile electronic device, comprising a frame and a laminated covering over at least a portion of the frame; and
a support portion pivotally coupled to the attachment base portion.

11. The holder and support apparatus of claim 10, wherein the frame of the attachment base portion comprises at least one magnetic element for engagement with a cooperative magnetic feature of the mobile electronic device.

12. The holder and support apparatus of claim 10, wherein the support portion comprises a ring-shaped element configured to allow a finger of a user to be inserted into an inner opening of the ring-shaped element.

13. The holder and support apparatus of claim 10, wherein the laminated covering comprises at least one flexible formable sheet material.

14. The holder and support apparatus of claim 13, wherein the laminated covering comprises multiple layers laminated and/or bonded over the frame of the attachment base portion.

15. The holder and support apparatus of claim 14, wherein the laminated covering comprises laminated layers selected from one or more of a polyurethane (PU) synthetic leather, a polycarbonate (PC) film, and/or a liner layer, and combinations thereof.

16. The holder and support apparatus of claim 10, wherein the laminated covering comprises an opening through which a coupling portion extends between the frame of the attachment base portion and the support portion.

17. The holder and support apparatus of any of claim 16, wherein the pivotal coupling between the support portion and the attachment base portion is located at a position selected from at or around the inside diameter of the attachment base portion, at or around the outside diameter of the attachment base portion, in-line with a medial portion of the attachment base portion, on top of the attachment base portion, and/or at any position between said locations.

18. The holder and support apparatus of claim 16, wherein the pivotal coupling provides a range of pivotal motion enabling various support configurations of the mobile electronic device on a support surface, including a portrait orientation, a landscape orientation, and/or an obliquely tilted orientation.

19. The holder and support apparatus of claim 16, wherein the pivotal coupling provides a range of pivotal motion enabling different support angles of the mobile electronic device relative to a support surface between 0° to 90°.

20. A method of manufacture of a holder and support apparatus for a mobile electronic device, the method comprising providing an attachment base portion, and applying a laminated covering over at least a portion of the attachment base portion.
